(19) United States
(12) Patent Application Publication
(10) Pub. No.: US 2024/0317154 A1
(43) Pub. Date: Sep. 26, 2024

(54) WIRE HARNESS

(71) Applicant: Yazaki Corporation, Tokyo (JP)

(72) Inventors: Naoto KOGURE, Shizuoka (JP); Hikaru Sano, Shizuoka (JP)

(73) Assignee: Yazaki Corporation, Tokyo (JP)

(21) Appl. No.: 18/680,216

(22) Filed: May 31, 2024

Related U.S. Application Data
(63) Continuation of application No. PCT/JP2023/005660, filed on Jan. 17, 2023.

(30) Foreign Application Priority Data
Feb. 28, 2022 (JP) 2022-028843

(51) Int. Cl. B60R 16/02; B60J 5/06

(52) U.S. Cl. CPC B60R 16/0215; B60J 5/06

(57) ABSTRACT

A wire harness includes a harness body that is a routing component that electrically connects a first electrical connection target installed on a slide door and a second electrical connection target installed on a vehicle body, and includes a route regulating portion that is routed along a link mechanism that couples the slide door and the vehicle body and reciprocates the slide door in a sliding direction with respect to the vehicle body and a harness fixing structure that fixes the route regulating portion to the link mechanism at least one location so as not to cause relative displacement between the route regulating portion and the link mechanism.

### CROSS-REFERENCE TO RELATED APPLICATION (S)

This application is a continuation application of International Application No. PCT/JP2023/005660 filed on Feb. 17, 2023 which claims the benefit of priority from Japanese Patent Application No. 2022-028843 filed on Feb. 28, 2022 and designating the U.S., the entire contents of which are incorporated herein by reference.

### BACKGROUND OF THE INVENTION

### 1. Field of the Invention

The present invention relates to a wire harness.

### 2. Description of the Related Art

Conventionally, a vehicle such as an automobile is mounted with a wire harness that electrically connects a power source (secondary battery or the like), an electrical component, and the like on a vehicle body side to a switch, an electrical component, and the like on a slide door side. This type of wire harness is disclosed in, for example, Japanese Patent Application Laid-open No. 2021-19386.

In a wire harness for a slide door, a harness body is routed between a vehicle body and a slide door, and a routing path of the harness body changes in conjunction with an opening/closing operation of the slide door. In such a wire harness, there is a possibility that a deflection occurs in the harness body due to running vibration of the vehicle or the like, and the harness body comes into contact with a peripheral component or is separated from the peripheral component. For this reason, in this wire harness, there is a possibility that an undesired result such as generation of abnormal noise is generated along with the contact of the harness body with the peripheral component, and thus, it is necessary to suppress the occurrence of deflection of the harness body.

### SUMMARY OF THE INVENTION

Therefore, an object of the present invention is to provide a wire harness for a slide door capable of suppressing occurrence of deflection of a harness body.

In order to achieve the above mentioned object, a wire harness according to one aspect of the present invention includes a harness body that is a routing component that electrically connects a first electrical connection target installed on a slide door and a second electrical connection target installed on a vehicle body, and includes a route regulating portion that is routed along a link mechanism that couples the slide door and the vehicle body and reciprocates the slide door in a sliding direction with respect to the vehicle body; and a harness fixing structure that fixes the route regulating portion to the link mechanism at least one location so as not to cause relative displacement between the route regulating portion and the link mechanism.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness of an embodiment as viewed from a vehicle interior side;

FIG. 2 is a perspective view of the wire harness of the embodiment as viewed from the vehicle interior side; and

FIG. 3 is a plan view of the wire harness of the embodiment as viewed from above a vehicle.

### DETAILED DESCRIPTION OF THE PREFERRED EMBODIMENTS

Hereinafter, an embodiment of a wire harness according to the present invention will be described in detail with reference to the drawings. Note that the present invention is not limited by the embodiment.

### Embodiment

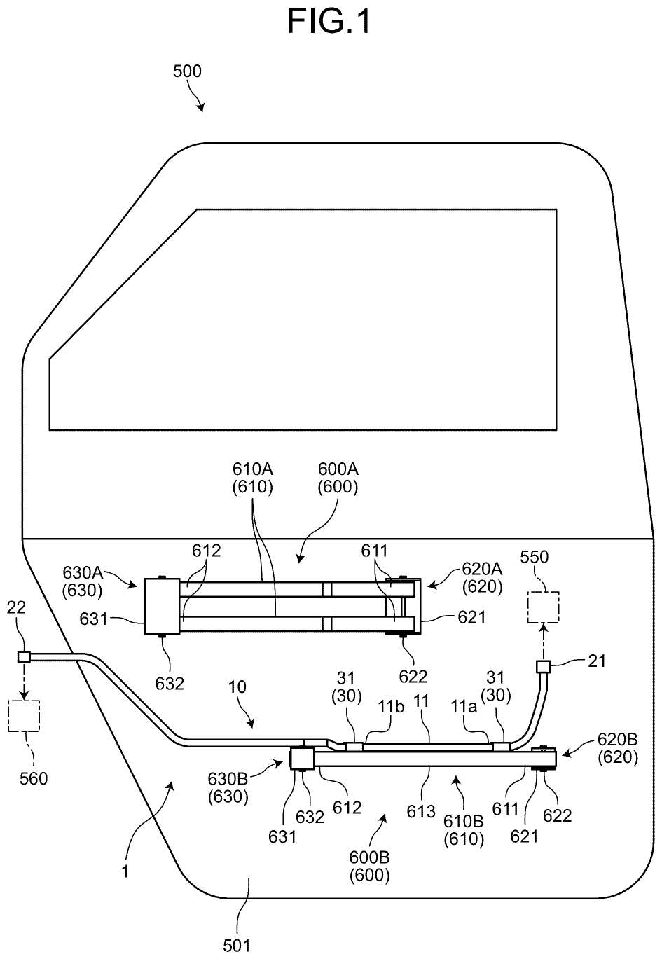

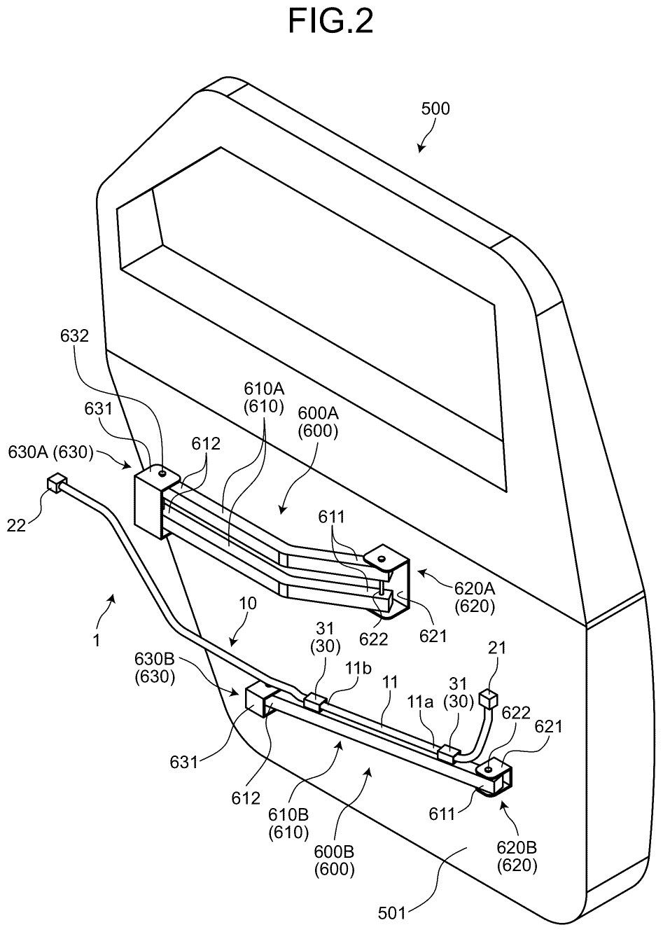

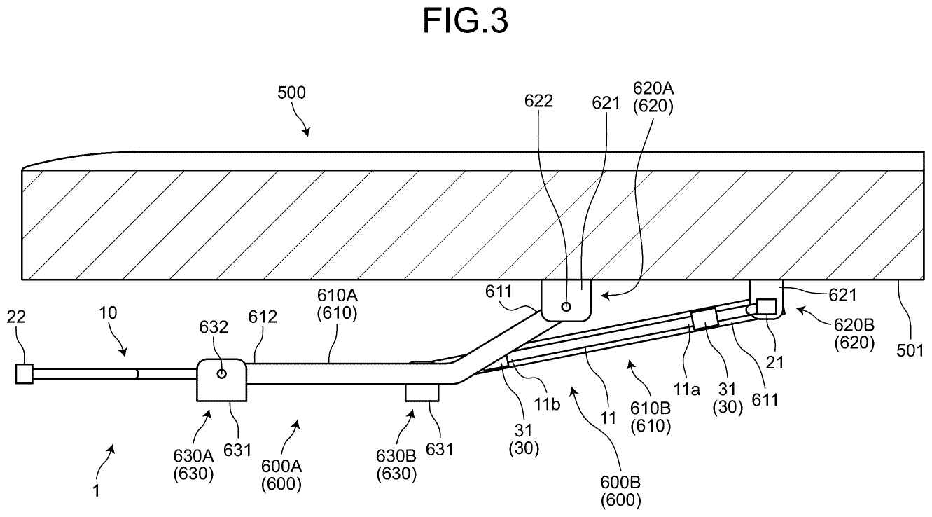

An embodiment of a wire harness according to the present invention will be described with reference to FIGS. 1 to 3.

Reference numeral 1 in FIGS. 1 to 3 denotes a wire harness of the present embodiment.

For example, in a vehicle such as an automobile, there is a vehicle on which a slide door 500 (FIGS. 1 to 3) capable of reciprocating in a sliding direction with respect to a vehicle body (not illustrated) is mounted. The vehicle includes a link mechanism 600 that couples the slide door 500 and the vehicle body and reciprocates the slide door 500 in the sliding direction with respect to the vehicle body in order to take charge of a slide operation (reciprocating operation in the sliding direction) of the slide door 500 (FIGS. 1 to 3). The link mechanism 600 illustrated here slides the slide door 500 on the vehicle side in a vehicle front-rear direction.

The link mechanism 600 is provided between the slide door 500 and the vehicle body to displace the slide door 500 with respect to the vehicle body between a fully open position and a fully closed position. The link mechanism 600 includes an arm member 610, a first bearing 620 fixed to the slide door 500 and pivotally supporting one end portion 611 of the arm member 610, and a second bearing 630 fixed to the vehicle body side and pivotally supporting the other end portion 612 of the arm member 610 (FIGS. 1 to 3). That is, the arm member 610 has a turning fulcrum (hereinafter, it is referred to as a “door-side turning fulcrum”) on the slide door 500 side of the link mechanism 600 at the one end portion 611, and has a turning fulcrum (hereinafter, it is referred to as a “vehicle body-side turning fulcrum”) on the vehicle body side of the link mechanism 600 at the other end portion 612.

The first bearing 620 includes a bracket 621 fixed to, for example, an inner panel 501 of the slide door 500, and a rotating shaft 622 having both ends rotatably assembled to the bracket 621 (FIGS. 1 to 3). The rotating shaft 622 is installed with an axial direction thereof aligned with a vehicle vertical direction. The one end portion 611 of the arm member 610 is fixed to the rotating shaft 622 and is pivotally supported by the bracket 621 so as to be rotatable around the axis of the rotating shaft 622. In addition, the second bearing 630 includes a bracket 631 fixed to the vehicle body and a rotating shaft 632 having both ends rotatably assembled to the bracket 631 (FIGS. 1 to 3). The rotating shaft 632 is installed with an axial direction thereof aligned with the vehicle vertical direction. The other end portion 612 of the arm member 610 is fixed to the rotating shaft 632 and is pivotally supported by the bracket 631 so as to be rotatable about the axis of the rotating shaft 632.

The link mechanism 600 reciprocates the slide door 500 in the sliding direction with respect to the vehicle body while rotating the arm member 610 at the door-side turning fulcrum of the one end portion 611 and the vehicle body-side turning fulcrum of the other end portion 612 by, for example, transmitting an output torque of a rotary machine (not illustrated) as a drive source to the rotating shaft 632 on the vehicle body side. In the link mechanism 600, for example, the arm member 610 is arranged in a state of extending in the sliding direction (here, the vehicle front-rear direction) of the slide door 500 when the slide door 500 is fully closed (FIGS. 1 to 3), and the arm member 610 is arranged in a state of extending in an intersecting direction (for example, the vehicle width direction) with respect to the sliding direction of the slide door 500 when the slide door 500 is at the fully open position.

A plurality of link mechanisms 600 are provided between the slide door 500 and the vehicle body. The plurality of link mechanisms 600 are arranged at intervals in the vehicle vertical direction. Here, as the link mechanism 600, an upper link mechanism 600A on the vehicle upper side and a lower link mechanism 600B on the vehicle lower side are provided (FIGS. 1 to 3). The upper link mechanism 600A includes two arm members 610A, a first bearing 620A that pivotally supports the one end portion 611 of each of the two arm members 610A, and a second bearing 630A that pivotally supports the other end portion 612 of each of the two arm members 610A (FIGS. 1 to 3). The lower link mechanism 600B includes one arm member 610B, a first bearing 620B that pivotally supports the one end portion 611 of the arm member 610B, and a second bearing 630B that pivotally supports the other end portion 612 of the arm member 610B (FIGS. 1 to 3). The drive source is connected to any one of the upper link mechanism 600A and the lower link mechanism 600B.

The wire harness 1 of the present embodiment is mounted on a vehicle in order to electrically connect a first electrical connection target 550 installed on the slide door 500 and a second electrical connection target 560 installed on the vehicle body (FIG. 1).

The first electrical connection target 550 is installed on the slide door 500 such as an electrical component or a switch. For example, the electrical components of the slide door 500 indicate a drive device that drives a power window, a speaker, and the like. The switch of the slide door 500 indicates a switch for operating a power window, a switch for operating a power seat, and the like. Meanwhile, the second electrical connection target 560 is installed on the vehicle body side such as a power source (secondary battery or the like) or an electrical component. For example, the electrical component on the vehicle body side indicates an acoustic device related to a speaker of the slide door 500, a drive device for driving a power seat, and the like.

The wire harness 1 includes a harness body 10 as a routing component that electrically connects the first electrical connection target 550 and the second electrical connection target 560 (FIGS. 1 to 3). The harness body 10 may be formed of only an electric wire bundle obtained by bundling a plurality of electric wires, the entire electric wire bundle may be covered with an exterior component such as a corrugated tube, or the electric wire bundle may be partially covered with one or a plurality of exterior components.

In the wire harness 1, one terminal of the harness body 10 is electrically connected directly or indirectly to the first electrical connection target 550, and the other terminal of the harness body 10 is electrically connected directly or indirectly to the second electrical connection target 560. The wire harness 1 illustrated here includes a first connector 21 that is assembled to one terminal of the harness body 10 and electrically connects the harness body 10 to the first electrical connection target 550 directly or indirectly, and a second connector 22 that is assembled to the other terminal of the harness body 10 and electrically connects the harness body 10 to the second electrical connection target 560 directly or indirectly (FIGS. 1 to 3).

The harness body 10 is routed along the link mechanism 600. Specifically, the harness body 10 includes a route regulating portion 11 routed along the link mechanism 600 (FIGS. 1 to 3). The route regulating portion 11 is a portion that keeps the routing path of the harness body 10 at a constant position with respect to the link mechanism 600 regardless of the sliding position of the slide door 500. The wire harness 1 includes a harness fixing structure 30 that fixes the route regulating portion 11 to the link mechanism 600 at at least one location so as to prevent the relative displacement between the route regulating portion 11 and the link mechanism 600 (FIGS. 1 to 3).

For example, the harness fixing structure 30 includes a fixing tool 31 for fixing the route regulating portion 11 to the link mechanism 600 for each place to be fixed (FIGS. 1 to 3). The fixing tool 31 is, for example, a clamp or a clip provided with respective holding shapes with respect to the route regulating portion 11 and the link mechanism 600 (for example, a portion formed in a flat plate shape), a resin tape that winds the route regulating portion 11 and the link mechanism 600 together, or the like.

The harness fixing structure 30 may fix the route regulating portion 11 to the brackets 621 and 631 of the link mechanism 600, or may fix the route regulating portion 11 to the arm member 610 of the link mechanism 600. The harness fixing structure 30 illustrated here fixes the route regulating portion 11 to the arm member 610 (FIGS. 1 to 3).

Here, the route regulating portion 11 is routed along the arm member 610. The harness fixing structure 30 fixes at least one end 11a and the other end 11b of the route regulating portion 11 to the arm member 610 (FIGS. 1 to 3).

In the harness body 10, for example, when the harness body 10 is routed along the arm member 610 between the one end portion 611 and the other end portion 612 of the arm member 610, a portion routed between the one end portion 611 and the other end portion 612 serves as the route regulating portion 11. In this case, the harness fixing structure 30 fixes the one end 11a of the route regulating portion 11 to the one end portion 611 of the arm member 610, and fixes the other end 11b of the route regulating portion 11 to the other end portion 612 of the arm member 610. For example, when a clamp or a clip is used as the fixing tool 31, the harness fixing structure 30 fixes at least two positions of the one end 11a and the other end 11b of the route regulating portion 11 to the one end portion 611 and the other end portion 612 of the arm member 610 with the fixing tool 31. Meanwhile, in the harness fixing structure 30, when the resin tape is used as the fixing tool 31, at least two positions of the one end 11a and the other end 11b of the route regulating portion 11 may be fixed to the one end portion 611 and the other end portion 612 of the arm member 610 by the fixing tool 31, and a portion between the one end 11a and the other end 11b of the route regulating portion 11 may be wound by the fixing tool 31 between the one end portion 611 and the other end portion 612 of the arm member 610 to form one fixing position.

In addition, in the harness body 10, for example, when the harness body 10 is routed along the arm member 610 between the one end portion 611 and a central portion 613 (FIG. 1) of the arm member 610, a portion routed between the one end portion 611 and the central portion 613 serves as the route regulating portion 11. In this case, the harness fixing structure 30 fixes the one end 11a of the route regulating portion 11 to the one end portion 611 of the arm member 610, and fixes the other end 11b of the route regulating portion 11 to the central portion 613 of the arm member 610. For example, when a clamp or a clip is used as the fixing tool 31, the harness fixing structure 30 fixes at least two positions of the one end 11a and the other end 11b of the route regulating portion 11 to the one end portion 611 and the central portion 613 of the arm member 610 with the fixing tool 31. Meanwhile, in the harness fixing structure 30, when the resin tape is used as the fixing tool 31, at least two positions of the one end 11a and the other end 11b of the route regulating portion 11 may be fixed to the one end portion 611 and the central portion 613 of the arm member 610 with the fixing tool 31, and a portion between the one end 11a and the other end 11b of the route regulating portion 11 may be wound with the fixing tool 31 between the one end portion 611 and the central portion 613 of the arm member 610 to form one fixing position.

The wire harness 1 is configured such that, for example, the harness body 10 is routed to at least one of the plurality of link mechanisms 600 (here, the upper link mechanism 600A and the lower link mechanism 600B). For example, the wire harness 1 may include the harness body 10 to be routed and fixed only to the upper link mechanism 600A, may include the harness body 10 to be routed and fixed only to the lower link mechanism 600B, or may include the harness body 10 to be routed and fixed to the upper link mechanism 600A and the harness body 10 to be routed and fixed to the lower link mechanism 600B. The wire harness 1 illustrated here includes a harness body 10 to be routed and fixed only to the lower link mechanism 600B (FIGS. 1 to 3).

In the wire harness 1, the harness body 10 may include a route regulating portion 11 along at least one of the plurality of link mechanisms 600 (here, the upper link mechanism 600A and the lower link mechanism 600B) (not illustrated). For example, the harness body 10 is branched for each electric wire routing target in the plurality of link mechanisms 600, and the route regulating portion 11 for each link mechanism 600 is provided in each branched portion. Therefore, in the harness body 10, the route regulating portion 11 is routed and fixed to the link mechanism 600 for each combination of the route regulating portion 11 and the link mechanism 600.

As described above, in the wire harness 1 of the present embodiment, since the route regulating portion 11 and the link mechanism 600 are fixed without relative displacement, it is possible to suppress the occurrence of deflection of the harness body 10 due to running vibration of the vehicle or the like. Therefore, since the wire harness 1 can suppress repetition of contact and separation of the harness body 10 with respect to the link mechanism 600 and the peripheral components, it is possible to suppress generation of abnormal noise between the harness body 10 and the link mechanism 600 and the peripheral components. Furthermore, the wire harness 1 can suppress deterioration in durability of the harness body 10, the link mechanism 600, and the peripheral components by suppressing repetition of contact and separation of the harness body 10 with respect to the link mechanism 600 and the peripheral components.

For example, the upper link mechanism 600A described here is disposed at a position visible from the vehicle interior regardless of the sliding position of the slide door 500. Therefore, the upper link mechanism 600A is covered with a protective component (not illustrated) from the outside. Therefore, in the harness body 10, when the route regulating portion 11 is routed along the upper link mechanism 600A, the generation of abnormal noise between the upper link mechanism 600A, the slide door 500, and the protective component can be suppressed by fixing between the upper link mechanism 600A and the route regulating portion 11 with the harness fixing structure 30. Meanwhile, the lower link mechanism 600B described here is disposed above the side sill and in a narrow space between the slide door 500 and the floor panel or between the slide door 500 and the seat when the slide door 500 is fully closed. For this reason, depending on the vehicle, it is difficult to cover the lower link mechanism 600B from the outside with a protective component like the upper link mechanism 600A. Therefore, in the harness body 10, when the route regulating portion 11 is routed along the lower link mechanism 600B, by fixing between the route regulating portion 11 and the lower link mechanism 600B with the harness fixing structure 30, it is possible to suppress generation of abnormal noise between the lower link mechanism 600B, the slide door 500, the side sill, the floor panel, and the seat.

In the wire harness according to the present embodiment, since the route regulating portion and the link mechanism are fixed without relative displacement, it is possible to suppress the occurrence of deflection of the harness body due to running vibration of the vehicle or the like. Therefore, since the wire harness can suppress repetition of contact and separation of the harness body with respect to the link mechanism and the peripheral component, it is possible to suppress generation of abnormal noise between the harness body and the link mechanism and the peripheral component. Furthermore, the wire harness can suppress deterioration in durability of the harness body, the link mechanism, and the peripheral component by suppressing repetition of contact and separation of the harness body with respect to the link mechanism and the peripheral component.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a harness body that is a routing component that electrically connects a first electrical connection target installed on a slide door and a second electrical connection target installed on a vehicle body, and includes a route regulating portion that is routed along a link mechanism that couples the slide door and the vehicle body and reciprocates the slide door in a sliding direction with respect to the vehicle body; and
a harness fixing structure that fixes the route regulating portion to the link mechanism at least one location so as not to cause relative displacement between the route regulating portion and the link mechanism.

2. The wire harness according to claim 1, wherein the harness fixing structure fixes the route regulating portion to an arm member having a door-side turning fulcrum of the link mechanism at one end portion and having a vehicle body-side turning fulcrum of the link mechanism at other end portion.

3. The wire harness according to claim 2, wherein in the harness fixing structure, one end of the route regulating portion is fixed to the one end portion of the arm member, and other end of the route regulating portion is fixed to the other end portion of the arm member.

4. The wire harness according to claim 1, wherein the harness body is routed to at least one of a plurality of the link mechanisms.

5. The wire harness according to claim 2, wherein the harness body is routed to at least one of a plurality of the link mechanisms.

6. The wire harness according to claim 3, wherein the harness body is routed to at least one of a plurality of the link mechanisms.

7. The wire harness according to claim 1, wherein the harness body includes the route regulating portion along at least one of a plurality of the link mechanisms.

8. The wire harness according to claim 2, wherein the harness body includes the route regulating portion along at least one of a plurality of the link mechanisms.

9. The wire harness according to claim 3, wherein the harness body includes the route regulating portion along at least one of a plurality of the link mechanisms.
